(19) United States
(12) Patent Application Publication
(10) Pub. No.: US 2019/0346897 A1
(43) Pub. Date: Nov. 14, 2019

(54) Introspective Power Method

(71) Applicant: Sean Joseph Rostami, Syracuse, NY (US)

(72) Inventor: Sean Joseph Rostami, Syracuse, NY (US)

(21) Appl. No.: 15/978,167

(22) Filed: May 13, 2018

(51) Int. Cl. G06F 1/26

(52) U.S. Cl. CPC G06F 1/26

(57) ABSTRACT

The well-known Power Method for approximating the largest eigenvalue of a linear operator is improved, without interfering with its standard functionality, so that the second-largest eigenvalue is also approximated. Simple linear combinations of normalized iterates are formed so that near-cancellation occurs and smaller eigenvalues become exposed. The approximations obtained in this way, while convergent in theory, closely approximate the true value only temporarily due to numerical instability. A statistical operation, akin to clustering, is provided to extract the approximation before instability takes hold.

### CROSS-REFERENCE TO RELATED APPLICATIONS

Not Applicable

### STATEMENT REGARDING FEDERALLY SPONSORED RESEARCH OR DEVELOPMENT

Not Applicable¹ ¹ All research contained herein was conducted independently and did not receive funding or support of any kind from any agency, organization, or individual.

### THE NAMES OF THE PARTIES TO A JOINT RESEARCH AGREEMENT

Not Applicable² ² No agency, organization, or individual besides the author was involved in the research contained herein.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Let V be a vector space and T: V→V a linear operator. A scalar λ is an eigenvalue for T exactly when there is a vector v≠0 such that T(v)=λv. For each such λ, such a v is an eigenvector for λ, and the set of v for which T(v)=λv is a subspace of V, the λ-eigenspace. The ideal situation is that there exists a basis for V consisting exclusively of eigenvectors—in this case, the operator T behaves like a diagonal matrix, and knowledge of the eigenvalues and eigenvectors drastically simplifies analysis of virtually anything involving T (cf. Chapter 5 of [2]). It is not always true that there is such a basis, but it is true for many important classes of operators (cf. § 5.6 of [2]), and is almost certain to be true for a random matrix. Regardless, eigenvalues and eigenvectors are desired throughout the sciences.

The standard way to express the concept of “eigenvalue” in finite terms, taught in all introductory courses on Linear Algebra, is via the “Characteristic Polynomial”. For any matrix A representing T, and with I the identity matrix and x a variable, the determinant det(xI−A) is the same polynomial, called the Characteristic Polynomial of T. Its roots are precisely the eigenvalues of T. Despite its conceptual value, it is comically difficult to calculate eigenvalues in this way unless T is very special or dim(V) is extremely small (cf. preface to Chapter 15 of [1]. In practice, eigenvalues are approximated to desired accuracy by using one of a suite of iterative methods, which are mostly descendants of Power Method.

The famous Power Method is one of the oldest and simplest methods for approximating eigenvalues. Suppose that A is a square matrix which has a unique eigenvalue λ₁ of largest magnitude. The iterates A(v), A²(v), A³(v), . . . of a random vector v increasingly point in the direction of an eigenvector for λ₁. Comparing two sufficiently accurate consecutive iterates yields an approximation of λ₁, and either is an approximation of an eigenvector for λ₁. For extremely large applications, it is the only practical method to approximate eigenvalues and eigenvectors due to the relatively low amount of arithmetic that it requires (cf. § 12.3 & § 15.2 [1]).

In the remainder of this specification, I describe and examine a useful improvement of Power Method: Introspective Power Method.

### REFERENCES (FOR THE BACKGROUND OF THE INVENTION)

[1] Lars Eldén, Matrix Methods in Data Mining and Pattern Recognition, Fundamentals of Algorithms, vol. 04, Society for Industrial and Applied Mathematics (SIAM), 2007.
[2] Gilbert Strang, Linear algebra and its applications, 3rd ed., Harcourt Brace Jovanovich, Inc., 1988.

### BRIEF SUMMARY OF THE INVENTION

Despite Power Method's age and widespread use, it seems (judging from books, articles, internet, conversations) to be unknown that one can extract more information from Power Method with very little additional computational cost or code: by carefully implementing a simple idea, one can also acquire an approximation of the second-largest eigenvalue λ₂. As is well-known, |λ₂/λ₁| is an indicator of the speed at which the iterates A^{k}(v) converge (in Projective Space) to an eigenvector. The origin of the improvement, which is also the reason for the term “Introspective”, is the simple observation that Power Method can learn about λ₂ by analyzing the speed at which its own iteration is converging (cf. § 2 & § 3 of the Detailed Description).

A specific example of a situation in which the matrix A can be very large and both λ₁, λ₂ are desired comes from Network Analysis, in which the underlying object is what mathematicians usually call a graph. With any graph G are associated several important matrices, such as the Adjacency Matrix A, and Spectral Graph Theory is the study of graphs via the eigenvalues and eigenvectors of these special matrices. There are many uses for λ₁ (cf. Chapter 3 of [1]), but lower eigenvalues like λ₂ also appear³. For example, the smallest number of cliques (subnetworks in which every pair of nodes is connected) into which a network can be subdivided is bounded by a simple expression involving λ₁, λ₂ (cf. no. 12 in § 3.6 of [1]). This λ₂ also has significance for Chromatic Numbers, in part because of the well-known duality between colorings and clique partitions. ³ It is important to remember that when Graph Theorists say “largest” and “second-largest”, they really mean “rightmost” and “second-rightmost”. Luckily, it is easy to shift an adjacency matrix so that the second-rightmost is indeed the second-largest, and undo the shift after eigenvalues are approximated.

Although the accuracy of the approximations of λ₂ provided by Introspective Power Method can vary and may be unsatisfactory in some circumstances, it is at least possible to state with fairly high confidence what is the minimum accuracy of the approximation (cf. § 6 of the Detailed Description). In any case, the cost of Introspective Power Method (cf. § 7 of the Detailed Description) is so modest and the successes so frequent that it should be used in essentially all situations in which λ₂ is valuable and Power Method is already the method of choice; in the cases where it fails to satisfy, one can resort to Deflated Power Method (next) with only a little waste.

The customary way to approximate λ₂ is to Deflate, which “deletes” λ₁ from A, and then apply Power Method again to approximate the now-largest λ₂ (cf. § 4.2 of [2]). The computational cost of this is significantly higher than what is proposed here. That said, it must be admitted that a second use of Power Method would provide an approximation of a λ₂-eigenvector and it seems difficult to extend this functionality to Introspective Power Method.

Working implementations are provided (cf. § 5 of the Detailed Description) in the form of Octave functions, which can be easily converted to MATLAB if desired. These implementations were used to produce all figures and data below.

### REFERENCES (FOR THE BRIEF SUMMARY OF THE INVENTION)

[1] Dragoš M. Cvetković, Michael Doob, and Horst Sachs, Spectra of Graphs: Theory and Application, Academic Press, 1979.
[2] Yousef Saad, Numerical methods for large eigenvalue problems, Classics in Applied Mathematics, vol. 66, Society for Industrial and Applied Mathematics (SIAM), 2011. Revised edition of the 1992 original.

### BRIEF DESCRIPTION OF THE SEVERAL VIEWS OF THE DRAWING(S)

FIG. 1—Illustrates the kind of data set that typically arises from Introspection, and shows clearly the data subset that must be extracted in order to approximate the subdominant eigenvalue λ₂.

FIG. 2—Illustrates that the data produced by Introspection can sometimes be considerably “noisier” than suggested by FIG. 1, which complicates efforts to extract the desired data subset.

FIG. 3—Illustrates that the notion of “pseudomode” (cf. § 3 of the Detailed Description) succeeds at extracting the desired approximation from the data depicted in FIG. 1.

FIG. 4—Similar to FIG. 3, but illustrates success for the “noisy” data depicted in FIG. 2.

FIG. 5—Illustrates that the notion of “pseudomode” is genuinely better than simpler approaches in some rare but no less real cases, by showing an example in which a more straightforward approach identifies the wrong data subset.

FIG. 6—Complements FIG. 5 by showing that “pseudomode” succeeds on the same data set.

FIG. 7—Illustrates the kind of situation in which Introspective Power Method fails to approximate the subdominant eigenvalue λ₂.

FIG. 8—Illustrates the extent to which the function pseudomode's return value sig (cf. § 5 & 6 of the Detailed Description) predicts accuracy, by showing a plot of accuracy vs. sig in 10000 randomized trials.

### DETAILED DESCRIPTION OF THE INVENTION

### 1. Notation

Denote by [symbol] the field of Real Numbers, and by [symbol] the field of Complex Numbers.

For any coordinate vector v, denote by vᵢ its ith coordinate. For two coordinate vectors v, w of the same size, denote by v·w their Dot Product. Fix a typical norm ∥ ∥, such as the 2-norm ∥ ∥₂ or the max-norm ∥ ∥_{∞}. The choice of ∥ ∥ is deliberately omitted to allow flexibility. For any matrix A, denote by A^{T} its ordinary transpose.

Given vectors v, w such that w≈cv for some scalar c, denote by w//v an approximation of c. Although this seems ill-defined, there are many concrete definitions of the // operation. For example, one can define w//v to be the Rayleigh Quotient v·w/v·v. One can also define w//v to be the ratio wᵢ/vᵢ for fixed i, or random i, or i which maximizes |vᵢ|, etc. The implementation of // is deliberately omitted to allow flexibility.

Let A be a Real square matrix. Assume that A is diagonalizable over [symbol] , although this is a stronger hypothesis than is truly necessary⁴ (cf. Theorem 4.1 of [1]). Let λ₁ be the distinct eigenvalues, numbered so that |λ₁|≥|λ₂|≥|λ₁| for all other i. Assume that |λ₁|>|λ₂|>|λᵢ| for all other i. Set ρ [symbol] |λ₂/λ₁|, which is a major predictor of Power Method's speed for A. ⁴ In fact, even the hypothesis of semisimplicity in Theorem 4.1 of [1] is not logically necessary, but convergence is so slow in the non-semisimple case that the extra generality is utterly useless in practice.

### 2. Estimates

To simplify the notation, assume that A has only three distinct eigenvalues. For any vector v, there are scalars aᵢ and unit eigenvectors vᵢ such that v=a₁v₁+a₂v₂+a₃v₃. Fix a v such that aᵢ≠0, which is satisfied in practice by using a “random” v. Denote by uₖ the kth normalized iterate of v by A, i.e. uₖ [symbol] ∥A^{k}(v)∥⁻¹ A^{k}(v).

By definition of “eigenvector”,

A^{k}(v)=a₁λ₁^{k}vᵢ+a₂λ₂^{k}v₂+a₃λ₃^{k}v₃

Since the v₁-term of A^{k}(v) dominates (in a relative sense) as k increases, the first thing to note is that

$${u}_{k} \approx \frac{1}{\vert {a}_{1} {λ}_{1}^{k} \vert} {A}^{k} ( v ) = {ϵ}_{k} {v}_{1} + \frac{{a}_{2}}{\vert {a}_{1} \vert} {( \frac{{λ}_{2}}{\vert {λ}_{1} \vert} )}^{k} {v}_{2} + \frac{{a}_{3}}{\vert {a}_{1} \vert} {( \frac{{λ}_{3}}{\vert {λ}_{1} \vert} )}^{k} {v}_{3}$$

for large k, where ϵₖ=sign(a₁λ₁^{k}).

DEFINITION (depth-2 aggregates). Define

$${δ}_{k} {=}^{def} \{ \begin{matrix}{u}_{k} - {u}_{k - 1} & if {λ}_{1} > 0 \\ {u}_{k} + {u}_{k - 1} & if {λ}_{1} < 0\end{matrix} .$$

Observe that, since ϵₖ is constant if λ₁>0 and alternating if λ₁<0,

$${δ}_{k} \approx \frac{{a}_{2}}{\vert {a}_{1} \vert} {( \frac{{λ}_{2}}{\vert {λ}_{1} \vert} )}^{k - 1} ( \frac{{λ}_{2}}{\vert {λ}_{1} \vert} \pm 1 ) {v}_{2} + \frac{{a}_{3}}{\vert {a}_{1} \vert} {( \frac{{λ}_{3}}{\vert {λ}_{1} \vert} )}^{k - 1} ( \frac{{λ}_{3}}{\vert {λ}_{1} \vert} \pm 1 ) {v}_{3} \qquad ( 1 )$$

for large k, where ±=sign(−λ₁).

The imprecise idea explained in the Brief Summary is made precise by observing that ∥δₖ∥/∥δₖ₋₁∥→ρ as k→∞ and, provided that (1) is reasonably accurate, sign(λ₂) can be deduced by checking whether the signs of the entries of δₖ are constant or alternating.

A superior viewpoint is that

$${δ}_{k} // {δ}_{k - 1} -> \frac{{λ}_{2}}{\vert {λ}_{1} \vert}$$

as k→∞.

At the conclusion of Power Method, a good approximation of λₗ is known. Monitoring the sequence δₖ provides an approximation of λ₂/|λ₁|. Thus, λ₂ is approximated.

However, all of this is theoretical and there are real obstacles to implementation. I discuss these next.

### 3. Numerics

Implementing § 2 requires two opposing demands to be satisfied simultaneously:
The iterates uₖ must converge enough that (1) is valid, but
they must not converge so much that δₖ has a large relative error.

In general, there is a “sweet spot” in which the approximation of λ₂/|λ₁| should be extracted, and it is almost a tautology that this occurs strictly after iteration begins but strictly before accuracy λ₁ is attained.

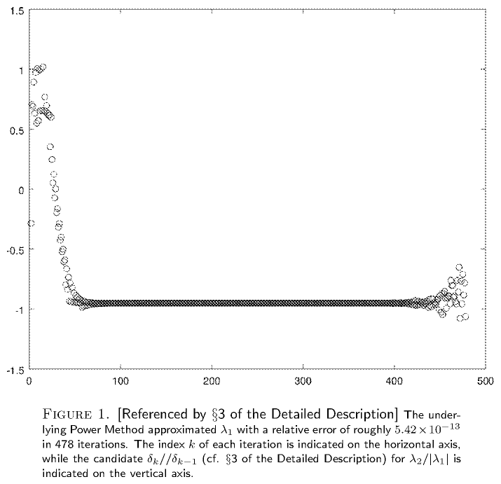

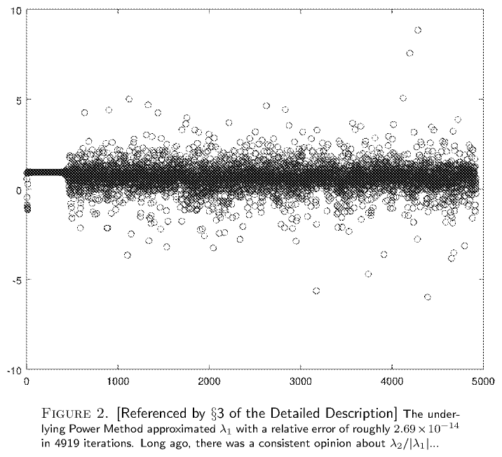

REFER TO FIGURES. FIG. 1 shows a sample plot of the candidates δₖ//δₖ₋₁ for λ₂/|λ₁|. The almost-constant value of the very conspicuous almost-linear subset of this plot is a good approximation of λ₂/|λ₁|. FIG. 2 shows a similar but much “noisier” sample plot, illustrating that the desired subset can be very elusive in practice.

The basic idea to extract subsets like those depicted in FIG. 1 is as follows:
(1) Collect the candidates δₖ//δₖ₋₁, one per iteration, for λ₂/|λ₁|.
(2) Repeatedly round the candidates to shorter and shorter lengths.
(3) After each rounding, calculate the mode (and frequency) of the candidates.
(4) Search the frequencies of these modes for a “spike”.
(5) Take the mode whose frequency caused the spike.

The point is that very few of the values in the desired subset are literally equal, and so do not exhibit their “true” multiplicity. However, after some rounding they coalesce into a single value which becomes the mode and has much larger frequency than previous modes. All subsequent roundings will increase frequency by smaller amounts.

The preceding description is an oversimplification of what actually happens, but conveys the main idea. In reality, what exactly “spike” should mean is a bit tricky. At present, the best approximations seem to result from selecting the mode whose frequency increased the most as a percentage of the previous mode's frequency:

DEFINITION (pseudomode). Let [symbol] be a sequence of Floating-Point Numbers, denote by mₛ the mode of the sequence obtained by rounding the elements of [symbol] to s significant digits, and by fₛ the frequency of mₛ. Define the pseudomode of [symbol] to be m_{S}, where S is the s maximizing (fₛ−fₛ₊₁)/fₛ₊₁. If there are multiple such s, the largest is chosen.

The pseudomode of the sequence δₖ//δₖ₋₁ is taken as the approximation of λ₂/|λ₁|. A straightforward implementation, in Octave, of the above definition is given in § 5 below. The computational cost of this function, called pseudomode, is discussed in § 7 below.

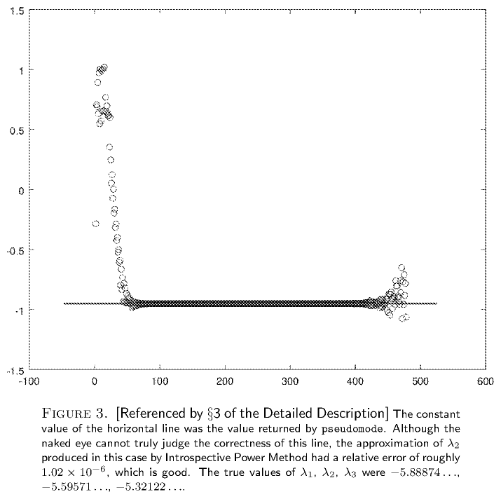

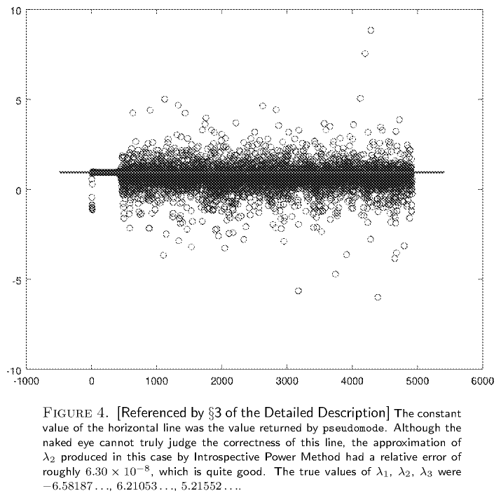

REFER TO FIGURES. FIG. 3 displays, as a genuine horizontal line, the value produced by pseudomode when applied to the same initial data as FIG. 1. Accuracy of the approximation of λ₂ thereby produced by Introspective Power Method is also provided, in the caption. FIG. 4 illustrates that pseudomode does a good job even when an enormous amount of noise is present, by treating the same initial data as FIG. 2.

The reader may naturally ask if a simpler approach is just as good as pseudomode. For example, one could simply wait until consecutive terms in the sequence δₖ₊₁//δₖ are sufficiently close and choose one as approximation of λ₂/|A₁|. It is plausible from the examples (see Figures) that such an approach is vulnerable to “coincidental closeness”, and this is indeed the case.

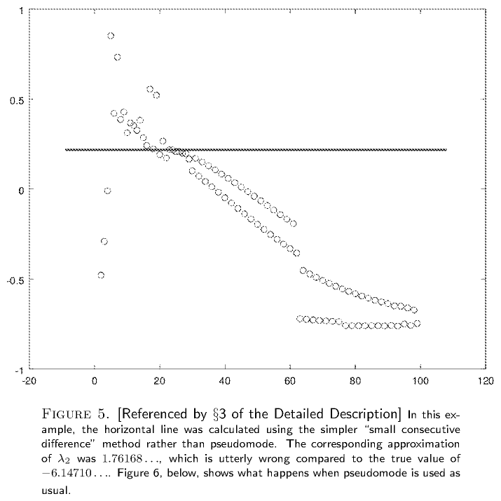

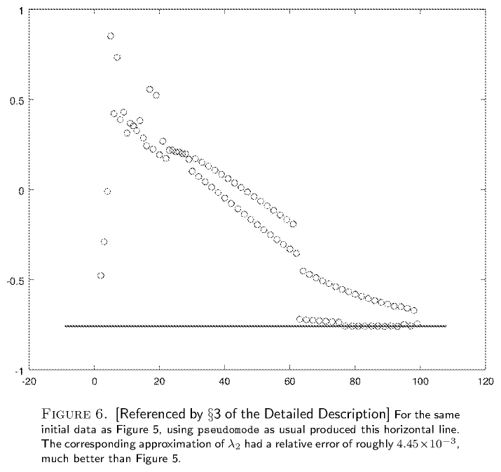

REFER TO FIGURES. FIG. 5 shows an example in which pseudomode was replaced with the simpler idea from the previous paragraph, and a completely wrong candidate for λ₂/|λ₁| is chosen. When the same initial data is treated using pseudomode, the result improves—see FIG. 6. This situation is actually very rare, but it happens.

A more important advantage of pseudomode over the simpler approaches is that it can provide some level of confidence regarding the accuracy of the approximation of λ₂; see § 6 for details.

### 4. Limitations

Of course, Introspective Power Method can fail for the same reasons that Power Method can fail. If |λ₂|≈|λ₃| then the candidates for λ₂/|λ₁| can fail to stabilize near the true value before the underlying Power Method terminates.

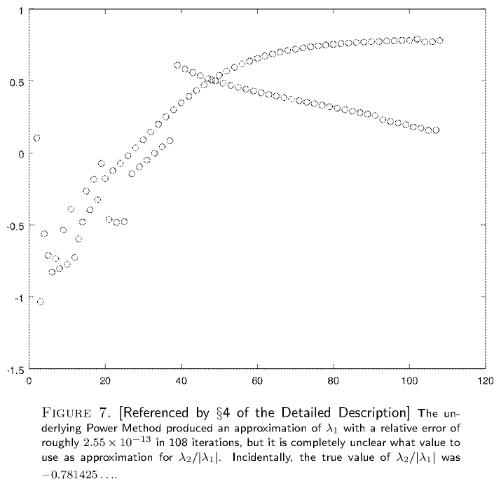

REFER TO FIGURES. FIG. 7 shows a case in which the approximation for λ₁ was quite accurate but the sequence δₖ//δₖ₋₁ did not yet stabilize.

Conceptually, there are three scenarios:
(1) |λ₂| is significantly closer to |λ₁| than |λ₃|. Convergence to λ₁ is slow and δₖ//δₖ₋₁ stabilizes relatively early in the iteration (similar to FIG. 2).
(2) |λ₂| is, in a relative sense, not particularly close to either |λ₁| or |λ₃|. Stabilization of δₖ//δₖ₋₁ is definitive (similar to FIG. 1).
(3) |λ₂| is significantly closer to |λ₃| than |λ₁|. Convergence to λ₁ is fast, before δₖ//δₖ₋₁ stabilized (similar to FIG. 7).

Scenario (3) is responsible for the vast majority of cases in which Introspective Power Method does not return a reasonably correct approximation of λ₂.

I further address the reliability of Introspective Power Method in § 6 below.

### 5. Code (Octave)

This section provides a complete implementation, in Octave, of Introspective Power Method. More specifically, this section provides an implementation of
an implementation, vecdiv, of the // operation,
an implementation, pseudomode, of the notion of pseudomode, and
IPM, the standard Power Method augmented by Introspection.

Since the underlying Power Method below uses ∥ ∥_{∞} to measure errors and normalize (cf. § 4.1.1 of [1]), the following seems to be a good implementation of the // operation:

% ″vecdiv″ (other implementations are possible)
% parameter ’v’ : a column vector of Real Numbers
% parameter ’cv’ : a column vector approximately parallel to ’v’
% return ’c’ : an approximation of ″the″ scalar C for which cv=C*v
function c = vecdiv( cv, v )

[ ~, k ] = max( abs( v ) ); % ″partial pivoting″
c = cv(k,1)/v(k,1); % (’vecdiv’ assumes v has a non-zero entry)

endfunction

To extract a good approximation of λ₂/|λ₁|, an implementation of the idea from § 3 is needed:

% ″pseudomode″
% parameter ’vals’ : a column vector of Real Numbers
% parameters ’maxsig’/’minsig’ : where to start/stop rounding
% return ’pm’ : where ’vals’ claimed to cluster (″pseudomode″)
% return ’sig’ : digits retained upon clustering (″significance″)
function [ pm, sig ] = pseudomode( vals, minsig, maxsig )

mfs = NaN( 1+maxsig−minsig, 2 ); % stores mode-frequency pairs
for k = maxsig : −1 : minsig % successively round and take mode

[ mfs(k+1−minsig,1), mfs(k+1−minsig,2), ~] =
mode(chop(vals,k));

end
K = NaN;
relchgf = NaN;
maxrelchgf = −1;
for k = maxsig−minsig : −1 : 1 % search frequencies

relchgf = ( mfs(k,2) − mfs(k+1,2) ) / mfs(k+1,2);
if( relchgf > maxrelchgf )

maxrelchgf = relchgf;
K = k; % store position of current largest

end

end
pm = mfs(K,1);
sig = K−1+minsig; % selected mode's number of digits

endfunction

REMARK. The additional return value sig is the number of significant digits not yet rounded when the pseudomode occurred. Its purpose is explained in § 6 below.

Finally, the following is an implementation of Introspective Power Method, using ∥ ∥_{∞} for all purposes:

% ″Introspective Power Method″ (depth 2)
% parameters ’A’, ’v’ : square matrix, vector on which to iterate
% return ’dom’ : the eigenvalue of ’A’ with largest magnitude
% return ’domv’ : a unit eigenvector for eigenvalue ’dom’
% parameter ’tol’ : if Power Method succeeds, error < ’tol’
% return ’it’ : iterations needed to accomplish accuracy ’tol’
% parameter ’maxit’ : maximum number of iterations to allow
% return ’sdom’ : the eigenvalue with second-largest magnitude
% ’sig’, ’minsig’, ’maxsig’ : as in ’pseudomode’
function [dom,domv,it,sdom,sig] = IPM2(A,v,tol,maxit,minsig,maxsig)

dff = NaN( rows( v ), 1 );
dffp = NaN( rows( v ), 1 );
rhos = NaN( maxit, 1 );
it = maxit;
for k = 1 : maxit

domv = v; % previous normalized iterate
v = A*domv; % current unnormalized iterate
dom = vecdiv( v, domv ); % current estimate of largest
eigenvalue
if( ( norm(v−(dom*domv),Inf) / abs(dom) ) < tol ) % check
error

it = k−1; % ″this″ iteration not done yet
break;

end
v = ( 1/norm(v,Inf) )*v; % current normalized iterate
dffp = dff;
if( dom > 0 ) dff = v − domv;
else dff = v + domv;
end % ’ifelse’ is less efficient (no short-circuit)
rhos(k,1) = vecdiv( dff, dffp );

end
if( it == maxit ) % tolerance unattained (re-run with ’domv’?)

dom = sdom = sig = NaN;

else

[ rho, sig ] = pseudomode( rhos( 2 : it, 1 ), minsig, maxsig );
sdom = abs(dom)*rho;

end

endfunction

REMARK. The required code (highlighted above) can be inserted into any implementation of Power Method and does not interfere with its standard functionality.

### 6. Validity

A central, and somewhat paradoxical, challenge for any approximation algorithm is to promise accuracy of the approximation compared to the unknown true value.

Power Method can promise something, because it approximates both the eigenvalue and an eigenvector: if and λ′₁ and v′₁ are approximations then the absolute residual error ∥A(v′₁)−λ′₁v′₁∥, or its relative version, can be checked.

REMARK. Strictly speaking, neither residual error implies anything definite about |λ′₁−λ₁| or |λ′₁−λ₁|/|λᵢ| (cf. (53.5) in Chapter 3 of [2] and § 3.2.1 of [1]).

What can Introspective Power Method promise? Although it is true, mathematically, that δₖ converges to a λ₂-eigenvector v₂ as k→∞, it seems difficult to get a good approximation of v₂ in practice without squandering much of the efficiency that makes the method advantageous. So, it is not possible at present to promise a residual error.

However, pseudomode's return value sig seems to be a reliable indicator of accuracy:

HEURISTIC (confidence). The relative error in the approximation of λ₂ is likely to be 10^{1-sig} or better, and extremely likely to be 10^{2-sig} or better.

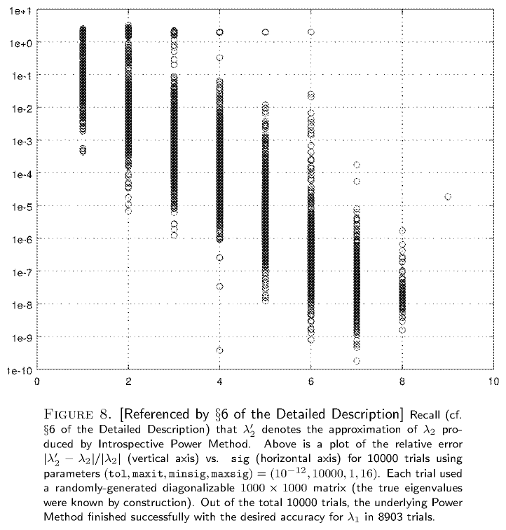

REFER TO FIGURES. FIG. 8 depicts the correlation between the relative error |λ′₂−λ₂|/|λ₂| and pseudomode's return value sig, from a batch of 10000 randomized trials. The proportion of trials for each sig=1, 2, 3, 4, 5, 6, 7, 8 with the claimed accuracy 10^{1-sig} is 63%, 73%, 84%, 89%, 93%, 98%, 98%, 91%. If one demanded accuracy for λ₂ of 10⁻³ or better and one's policy was to trust only those approximations of λ₂ for which sig≥4 then the approximation of λ₂ produced by Introspective Power Method would be satisfactory in 5304 out of 5618 trials (roughly 94%).

If less accuracy for λ₁ is demanded then, for reasons discussed in § 3, one should expect the approximation of λ₂ to degrade somewhat on average. A batch of 10000 randomized trials similar to that shown in FIG. 8, but with tol=10⁻⁰ instead of 10⁻¹², suggests that if one demanded accuracy for λ₂ of 10⁻³ or better and one's policy was to trust only those approximations of λ₂ for which sig≥4 then the approximation of λ₂ produced by Introspective Power Method would be satisfactory in 4945 out of 5482 trials (roughly 90%).

REMARK. For details about how the above trials were randomized, see Appendix B.

### 7. Efficiency

In this section, I show that the extra computational cost when Introspection is added to Power Method is considerably smaller than the cost to subsequently run Deflated Power Method.

Let n×n be the size of A. Let N be the number of iterations performed during Introspective Power Method, which depends only on the underlying Power Method and is unaffected by the improvement. Let M be the number of successive roundings to be performed by the pseudomode function (cf. § 5 above). Since M is bounded by a very small number dependent only on the floating-point system and the granularity of rounding (e.g. M≤17 in Double Precision with Decimal rounding), it will be treated as a constant in the asymptotic θ-notation.

Here is a list of the “new” operations added to Power Method:
(a) In each iteration, one Add (or Subtract) is performed on a pair of n-vectors.
(b) In each iteration, one // is performed on a pair of n-vectors.
(c) After iteration is completed, round an N-array M times.
(d) After each rounding in (c), calculate the mode of an N-array.
(e) Finally, search a M-array of mode-frequency pairs for a “spike”.

The cost of the procedure in (a) is linear in n and so complexity (a) is, in asymptotic notation, Nθ(n). The cost of any reasonable implementation of // is also linear in n and so complexity (b) is Nθ(n). By nature of M and because the cost of rounding a single Floating-Point Number can be assumed fixed, complexity (c) is Nθ(1). One way to efficiently accomplish (d) is to sort the initial N-array first, observe that rounding does not cause the array to become unsorted, and note that the mode of any sorted array can be easily calculated during a single traversal of the array. Expressed in asymptotic notation, complexity (d) is θ(N log(N))+θ(N). By nature of M and because the procedure required by (e) is very simple, cost (e) can be safely ignored.

SUMMARY. In terms of routine low-level operations like Floating-Point Arithmetic/Comparison, the extra computational cost required to run Power Method when Introspection is included is, in asymptotic notation, θ(Nn+N log(N)); the leading coefficients are modest.

On the other hand, the components of Deflated Power Method are as follows:
(A) Deflation itself, which may occur either inside or outside of the main iteration, depending on various considerations (cf. Appendix A).
(B) In each iteration, one Matrix-Vector product with an n×n matrix.
(C) In each iteration, one // is performed on a pair of n-vectors.
(D) In each iteration, one n-vector is normalized.

I assume that the number of iterations needed for the second use of Power Method is the same N, because no other assumption seems more reasonable.

REMARK. The assumption in the previous paragraph simplifies the analysis of complexity, but it should be noted there are meaningful relationships between the performance of Introspection and that of Deflated Power Method. For example, the situation in which Introspective Power Method is most likely to produce a poor approximation is precisely the situation in which Deflated Power Method is likely to require a large number of iterations (cf. § 4).

The cost of the procedure in (B) is quadratic in n so complexity (B) is, in asymptotic notation, Nθ(n²). As before, complexity (C) is Nθ(n). The cost of the procedure in (D) is linear in n so complexity (D) is Nθ(n). Depending on whether Deflation is accomplished inside or outside of the main iteration, complexity (A) will be either Nθ(n) or θ(n²), respectively.

SUMMARY In terms of routine low-level operations like Floating-Point Arithmetic (including \sqrt{ }), the computational cost required to run Deflated Power Method is, in asymptotic notation, θ(Nn²); the leading coefficients are modest.

There is no rigorous relationship between n and N, and I prefer not to impose any such assumption. Nonetheless, for the computational cost of Deflated Power Method to be competitive with Introspection, the number N of iterations would need to be unrealistically larger than the size n of the matrix. To get a rough idea of the scale, note that if A is merely 10×10 then the smallest N for which Nn²<N log₂(N) is roughly N≈10³⁰.

Introspective Power Method's other costs, like storage/reads/writes are moderate. For example, the extra memory required is
Two extra n-vectors to store δₖ, δₖ₋₁ during each iteration k.
One extra N-array to hold the candidates δₖ//δₖ₋₁ for λ₂/|λ₁|.
Various other incidental variables that can safely be ignored.

### 8. Extensions

By arranging deeper cancellation, one can approximate smaller eigenvalues:

DEFINITION (depth-3 aggregates). Define

$${η}_{k} {=}^{def} \{ \begin{matrix}{δ}_{k} - {ρδ}_{k - 1} & if {λ}_{2} > 0 \\ {δ}_{k} + {ρδ}_{k - 1} & if {λ}_{2} < 0\end{matrix} ,$$

where λ₂, ρ, δₖ are as before.

Observe that

$${η}_{k} \approx {( \frac{{λ}_{3}}{\vert {λ}_{1} \vert} )}^{k - 2} \cdot C \cdot {v}_{3}$$

for a certain constant C, and therefore

$${η}_{k} // {η}_{k - 1} \approx \frac{{λ}_{3}}{\vert {λ}_{1} \vert}$$

for large k. This requires storage and update of δₖ₋₂ in addition to δₖ and δₖ₋₁.

A general definition is:

DEFINITION (depth-i aggregates). Define δₖ⁽ⁱ⁾ recursively by

$${δ}_{k}^{( 1 )} {=}^{def} {u}_{k}$$

$${δ}_{k}^{( i )} {=}^{def} {δ}_{k}^{( i - 1 )} - \frac{{λ}_{i - 1}}{\vert {λ}_{1} \vert} {δ}_{k - 1}^{( i - 1 )}$$

Note that δₖ⁽²⁾=δₖ and δₖ⁽³⁾=ηₖ.

Observe that

$${δ}_{k}^{( i )} // {δ}_{k - 1}^{( i )} \approx \frac{{λ}_{i}}{\vert {λ}_{1} \vert}$$

for large k.

REMARK. Of course, errors become compounded as i increases, so one cannot go very deep before the approximations become mostly garbage. On the other hand, this is somewhat of an obstacle for Deflated Power Method too (cf. § 4.2.5 of [1]).

Finally, Introspective Power Method can be used in the Complex setting with no significant changes. Given an implementation of Power Method that itself operates in the Complex setting, simply observe that cancellation of dominant terms in the sequence of normalized iterates uₖ is arranged by forming uₖ−ζuₖ₋₁, where now ζ [symbol] λ₁/|λ₁| is a “complex sign”, i.e. root of unity.

### APPENDIX A: DEFLATION

Let A and λᵢ be as above.

Let u₁ be a unit eigenvector for λ₁. Let u be any vector such that u·u₁=1; one choice for u is u₁ but there are other choices (cf. § 4.2.5 of [1]). Define U to be the outer product u₁·u^{T} of u₁ and u.

For any number λ, the eigenvalues of A−λU are λ₁−λ, λ₂, . . . (cf. Theorem 4.2 of [1]). Thus, if λ is chosen to be λ₁ then the largest eigenvalue of A−λU is λ₂. Deflated Power Method for A is simply the application of Power Method to A−λ₁U. There is a non-trivial correspondence between eigenvectors of A and eigenvectors of A−λU (cf. § 4.2.1 of [1]). Note that Deflated Power Method is effective even if λ is merely an approximation of λ₁, since then λ₁−λ≈0 and λ₂ is probably still the largest eigenvalue of A−λ₁U.

A key point is that Power Method can be used on A−λU without ever actually modifying A, since outer products transform vectors in a predictable and simple way:

If Z is the outer product of x and y then Z(v)=(y·v)x. Thus, (A−λU)(v) can be determined by separately calculating A(v) and the comparatively inexpensive λ₁U(v). This is significant when sparseness is important, since A−λU is usually extremely dense (cf. § 4.2.5 of [1]).

### APPENDIX B: RANDOMIZATION

For all randomized trials above, the matrix A was generated as follows:
(1) A non-negative diagonal matrix D was randomly generated using Octave's rande function⁵, and each value made negative with probability ½.
(2) A matrix S was randomly generated using Octave's rand function. Such an S is almost certainly invertible.
(3) The matrix A was defined by A [symbol] S·D·S⁻¹. This A is diagonalizable. Its eigenvalues are known by construction, so true errors can be calculated. ⁵ The rande function produces exponentially distributed floating-point numbers. This ensures that the large eigenvalues are not hopelessly clustered, as they would be if a uniform distribution was used.

### REFERENCES (FOR THE DETAILED DESCRIPTION OF THE INVENTION)

[1] Yousef Saad, Numerical methods for large eigenvalue problems, Classics in Applied Mathematics, vol. 66, Society for Industrial and Applied Mathematics (SIAM), 2011. Revised edition of the 1992 original.
[2] J. H. Wilkinson, The algebraic eigenvalue problem, Monographs on Numerical Analysis, The Clarendon Press, Oxford University Press, New York, 1988. Oxford Science Publications.

### ADDITIONAL REFERENCES

[1] Ilse C. F. Ipsen, Numerical matrix analysis: Linear systems and least squares, Society for Industrial and Applied Mathematics (SIAM), 2009.
[2] G. W. Stewart, Matrix algorithms Vol. II: Eigensystems, Society for Industrial and Applied Mathematics (SIAM), 2001.

1) The invention claimed is an improvement of Power Method, the latter and former being as follows:
Power Method being the widely known method by which a linear operator's dominant eigenvalue, assuming that such is unique, is approximated by repeatedly applying the operator to a suitable initial vector, normalizing each resulting vector relative to one or another norm, and calculating one or another quotient by said vector of the image of said vector under the linear operator after suitably many repetitions,
wherein the improvement comprises the aggregation of said vectors in such a way as to drastically reduce or eliminate the dominant terms, thereby exposing the subdominant term to potential treatment by technique similar to that used at the conclusion of Power Method.

2) Dependent on claim 1), the invention claimed is the further aggregation of said vectors in such a way as to drastically reduce or eliminate the subdominant term, subsubdominant term, etc., thereby exposing any term desired to potential treatment by technique similar to that used at the conclusion of Power Method.

3) The invention claimed is pseudomode, which is a technique for approximating the limit of a numerical sequence that is, in theory, convergent in the traditional mathematical sense but fails, in practice, to maintain convergence due to computational inaccuracy, and which is comprised of the following steps
The repeated rounding or truncation of the mantissas of the numbers involved in the sequence to shorter and shorter lengths,
the determination of the mode, and the mode's frequency, of each sequence of rounded or truncated elements,
the identification of the mode whose frequency increased the most relative to the frequency of the immediately preceding mode, and
the use of said mode as an approximation of the mathematical limit.
